(19) United States
(12) Patent Application Publication
(10) Pub. No.: US 2009/0017351 A1
(43) Pub. Date: Jan. 15, 2009

(54) FUEL CELL SYSTEM

(76) Inventor: Kota Manabe, Aichi (JP)

Correspondence Address: KENYON & KENYON LLP, 1500 K STREET N.W., SUITE 700, WASHINGTON, DC, 20005, US

(21) Appl. No.: 12/278,705

(22) PCT Filed: Jun. 28, 2007
(86) PCT No.: PCT/JP2007/063402

§ 371 Date: Aug. 7, 2008

(30) Foreign Application Priority Data
Jul. 18, 2006 (JP) 2006-195968

(51) Int. Cl. H01M 8/04

(52) U.S. Cl. 429/24

(57) ABSTRACT

There is disclosed a fuel cell system capable of performing low-temperature countermeasure control at an appropriate timing when necessary. To judge necessity of the low-temperature countermeasure control, a control unit performs automatic judgment based on surrounding environment information supplied from a navigation system and indicating a state (an outside air temperature or the like) of a surrounding environment. Then, the control unit weighs both of a judgment result of this automatic judgment and a judgment result of switch judgment based on user's operation of a low-temperature countermeasure control switch, and performs final judgment based on the respective weighted judgment results.

### TECHNICAL FIELD

The present invention relates to a fuel cell system.

### BACKGROUND ART

In a case where an outside temperature is low, there are a problem that water produced in a fuel cell system freezes to break pipes, valves and the like after stop of the system, and a problem that the frozen water blocks a gas channel and disturbs supply of a gas and an electrochemical reaction does not sufficiently proceed at a time when a fuel cell is started next time.

In view of such a problem, a method has been suggested in which temperature information such as an outside air temperature is acquired at a predetermined timing after a request for the stop of the fuel cell system (an instruction to turn off an ignition key or the like) has been made, and the freezing of the water is presumed from the temperature information and notified to a user (e.g., see Patent Document 1).

According to such a method, the user judges based on a presumption result (e.g., “there is a possibility of the freezing”) displayed in a display or the like whether or not low-temperature countermeasure control (sweep processing or the like) is necessary, and presses a low-temperature countermeasure performing button or the like according to the judgment result. Therefore, the low-temperature countermeasure control is performed only at a time when the user judges that the control is necessary.

### [Patent Document 1] Japanese Patent Application Laid-Open No. 2005-108832

### DISCLOSURE OF THE INVENTION

However, in a case where it is determined only based on user's judgment whether or not to perform low-temperature countermeasure control (i.e., whether or not to perform a pressing operation of a low-temperature countermeasure performing button), a problem occurs that the low-temperature countermeasure control is not performed at an appropriate timing owing to user's wrong judgment. In a case where the user overlooks the above message, a problem that any low-temperature countermeasure control is not performed occurs regardless of user's intention.

The present invention has been developed in view of the above-mentioned situation, and an object thereof is to provide a fuel cell system capable of performing low-temperature countermeasure control at an appropriate timing when necessary.

To solve the above-mentioned problem, a fuel cell system according to the present invention is a fuel cell system provided with a low-temperature countermeasure operator which instructs execution of low-temperature countermeasure control, the system comprising: first judgment means for judging necessity of the low-temperature countermeasure control based on acquired environment information; second judgment means for judging the necessity of the low-temperature countermeasure control based on operation contents of the low-temperature countermeasure operator operated by a user; weighting means for applying weights to judgment results obtained by the respective judgment means; and third judgment means for finally judging whether or not to execute the low-temperature countermeasure control based on the respective weighted judgment results.

According to such a constitution, when the necessity of the low-temperature countermeasure control is judged, both a judgment result of automatic judgment based on the environment information and a judgment result of switch judgment based on a user's operation of a low-temperature countermeasure control switch are weighted, and the final judgment is performed based on the respective weighted judgment results. Such weighting is performed, whereby precision of the judgment concerning the necessity of the low-temperature countermeasure control can be improved, and useless low-temperature countermeasure control can be suppressed. Moreover, the low-temperature countermeasure control can be performed at an appropriate timing when necessary.

Here, in the above-mentioned constitution, a configuration is preferable in which the weighting means changes the weight to be applied in accordance with contents of the acquired environment information, and a configuration is preferable in which the environment information includes information indicating at least one of a temperature of a fuel cell, an outside air temperature, a position at the time and a date.

As described above, according to the present invention, the low-temperature countermeasure control can be performed at the appropriate timing when necessary.

### BRIEF DESCRIPTION OF THE DRAWINGS

FIG. 1 is a diagram showing a constitution of a fuel cell system according to the present embodiment;

FIG. 2 is a diagram showing a navigation system according to the embodiment;

FIG. 3 is a flow chart showing judgment processing according to the embodiment;

FIG. 4 is a diagram illustrating a storage state of a memory according to the embodiment; and

FIG. 5 is a diagram illustrating judgment results A, B according to the embodiment.

### BEST MODE FOR CARRYING OUT THE INVENTION

An embodiment of the present invention will hereinafter be described with reference to the drawings.

### A. Present Embodiment

(1) Constitution of Embodiment

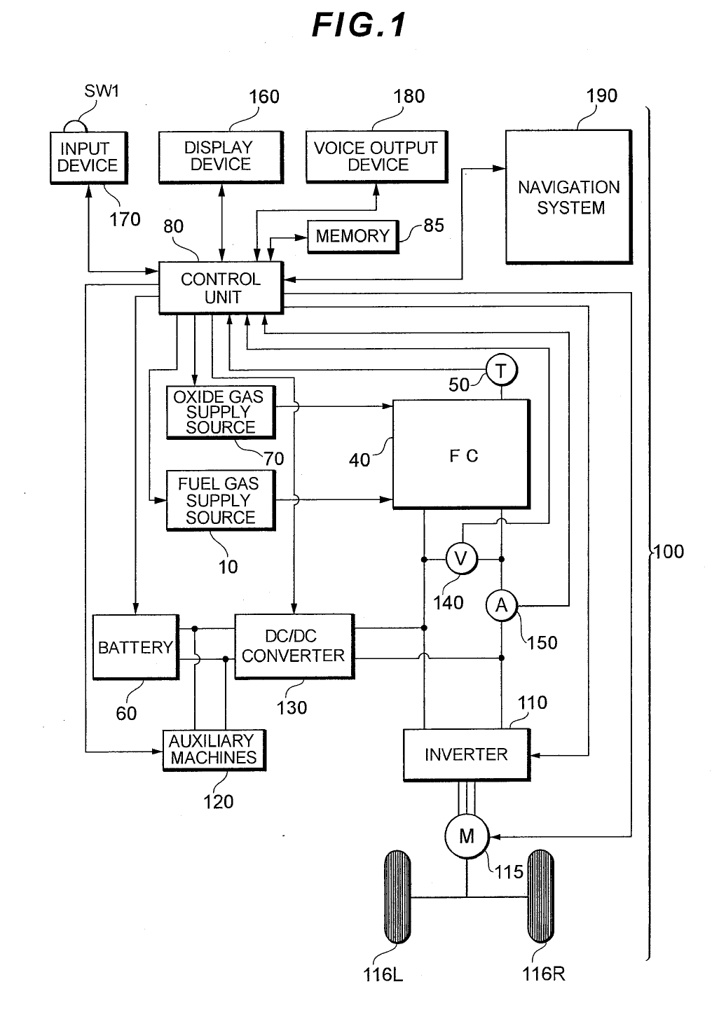

FIG. 1 is a diagram showing a main constitution of a fuel cell system 100 according to a first embodiment. In the present embodiment, a fuel cell system to be mounted on vehicles such as a fuel cell hybrid vehicle (FCHV), an electric car and a hybrid car is assumed, but the present embodiment is applicable to not only the vehicle but also various mobile bodies (e.g., a ship, an airplane, a robot, etc.) and a stationary power source.

A fuel cell 40 is means for generating a power from a supplied reactive gas (a fuel gas and an oxide gas), and any type of fuel cell such as a solid polymer type, a phosphoric acid type or a dissolved carbonate type may be used. The fuel cell 40 has a stack structure in which a plurality of unitary cells including an MEA and the like are laminated in series. An output voltage (hereinafter referred to as an FC voltage) and an output current (hereinafter referred to as an FC current) of this fuel cell 40 are detected by a voltage sensor 140 and a current sensor 150, respectively. A fuel gas such as a hydrogen gas is supplied from a fuel gas supply source 10 to a fuel pole (an anode) of the fuel cell 40, whereas an oxide gas such as air is supplied from an oxide gas supply source 70 to an oxygen pole (a cathode).

The fuel gas supply source 10 is constituted of, for example, a hydrogen tank, various valves and the like, and a valve open degree, an ON/OFF time and the like are adjusted to control an amount of the fuel gas to be supplied to the fuel cell 40.

The oxide gas supply source 70 is constituted of, for example, an air compressor, a motor for driving the air compressor, an inverter and the like, and a rotation number of the motor and the like are adjusted to adjust an amount of the oxide gas to be supplied to the fuel cell 40.

A battery 60 is a chargeable/dischargeable secondary cell, and is constituted of, for example, a nickel hydrogen battery or the like. Needless to say, instead of the battery 60, a chargeable/dischargeable power accumulator (e.g., a capacitor) other than the secondary cell may be provided. This battery 60 is connected in parallel with the fuel cell 40 via a DC/DC converter 130.

An inverter 110 is, for example, a PWM inverter of a pulse width modulation system, converts a direct-current power output from the fuel cell 40 or the battery 60 into a three-phase alternating-current power in response to a control instruction given by a control unit 80, and supplies the power to a traction motor 115. The traction motor 115 is a motor (i.e., a power source of the mobile body) for driving wheels 116L, 116R, and the rotation number of such a motor is controlled by the inverter 110. This traction motor 115 and the inverter 110 are connected to the side of the fuel cell 40.

The DC/DC converter 130 is, for example, a full bridge converter constituted of four power transistors and a drive circuit for exclusive use (both are not shown in the drawing). The DC/DC converter 130 has a function of raising or lowering a DC voltage input from the battery 60 to output the voltage to the fuel cell 40 side, and a function of raising or lowering the DC voltage input from the fuel cell 40 or the like to output the voltage to a battery 60 side. Charging and discharging of the battery 60 are realized by the functions of the DC/DC converter 130.

Auxiliary machines 120 such as vehicle auxiliary machines and FC auxiliary machines are connected between the battery 60 and the DC/DC converter 130. The battery 60 is a power source for these auxiliary machines 120. It is to be noted that the vehicle auxiliary machines are various electric apparatuses (an illumination apparatus, an air conditioning apparatus, a hydraulic pump, etc.) for use during driving of the vehicle, and the FC auxiliary machines are various power apparatuses (a pump for supplying the fuel gas and the oxide gas, etc.) for use in operating the fuel cell 40.

The control unit 80 is constituted of a CPU, an ROM, an RAM and the like, and centrically controls sections of the system based on sensor signals input from the voltage sensor 140, the current sensor 150, a temperature sensor 50 which detects a temperature of the fuel cell 40, an SOC sensor which detects a charged state of the battery 60, an accelerator pedal sensor which detects an open degree of an accelerator pedal and the like.

A display device 160 is constituted of a liquid crystal display device, various lamps and the like, and a voice output device 180 is constituted of a speaker, an amplifier, a filter and the like. The control unit 80 notifies various messages by use of the display device 160 and the voice output device 180. The messages to be notified include a message (e.g., display of a message which urges input of a low-temperature countermeasure control instruction) concerning low-temperature countermeasure control such as warm-up processing or sweep processing.

An input device 170 is constituted of a keyboard, a mouse, a touch panel, various operation switches and the like. The operation switches include a special switch (hereinafter referred to as a low-temperature countermeasure switch) SW1 for inputting a low-temperature countermeasure control start/control stop command. A user performs an operation to turn on or off this low-temperature countermeasure switch (a low-temperature countermeasure operator) SW1 to instruct low-temperature countermeasure control start/control stop.

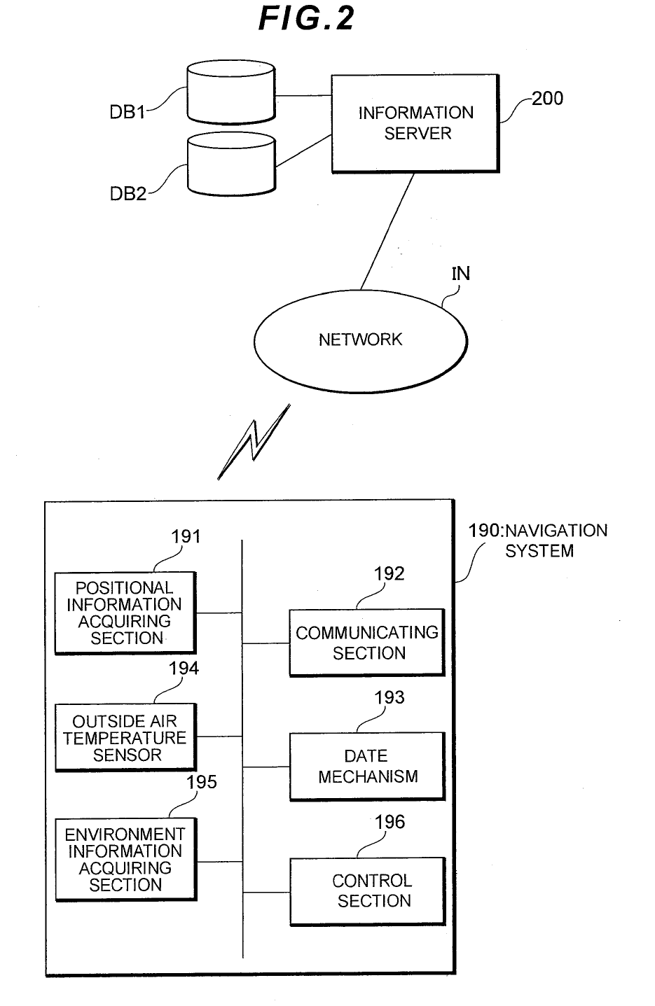

A navigation system 190 includes a CPU, an ROM, an RAM and the like, measures a position of the vehicle by use of a global positioning system (GPS) or the like, and displays the measured position together with a map of a surrounding area. FIG. 2 is a diagram showing a functional constitution of the navigation system 190.

The navigation system 190 includes a positional information acquiring section 191, a communicating section 192, a date mechanism 193, an outside air temperature sensor 194, an environment information acquiring section 195 and a control section 196.

The positional information acquiring section 191 includes a GPS, an electronic compass module and the like, and generates positional information (information indicating latitude and longitude, etc.) indicating the present position of the vehicle.

The communicating section 192 includes various communication interfaces, and transmits and receives various pieces of information to and from an information server 200 via a network (internet or the like) IN.

The date mechanism 193 is constituted of a timer and the like, and generates present time information indicating the present date and time (1 a.m., Jan. 1, 2007 or the like).

The outside air temperature sensor 194 is a sensor which detects an outside air temperature of the vehicle to generate outside air temperature information, and is provided on, for example, an outer periphery of the vehicle. It is to be noted that instead of directly detecting the outside air temperature, temperatures of various components (the respective auxiliary machines, etc.) mounted on the vehicle may be detected to indirectly detect the outside air temperature.

The environment information acquiring section 195 is means for acquiring information on a surrounding environment of the vehicle. The environment information acquiring section 195 transmits positional information acquired by the positional information acquiring section 191 to the information server 200 via the network IN to acquire map information, weather information and the like transmitted from the information server 200.

The information server 200 includes a map database DB1, a weather database DB2 and the like, and returns the map information indicating the present position of the vehicle and a surrounding district, the weather information indicating weather of the surrounding district and the like to the environment information acquiring section 195 in response to request from the environment information acquiring section 195. The environment information acquiring section 195 acquires the present time information from the date mechanism 193, and acquires outside air temperature information from the outside air temperature sensor 194. Furthermore, the environment information acquiring section 195 acquires FC temperature information indicating the temperature of the fuel cell and the like from the temperature sensor 50.

It is to be noted that in the following description, information on the surrounding environment of the vehicle, for example, the map information, the weather information, the present time information, the outside air temperature information and the FC temperature information will generically be referred to as the surrounding environment information.

The control section 196 is constituted of a CPU, an ROM, an RAM and the like, centrically controls the whole system and sends to the control unit 80 the surrounding environment information acquired by the environment information acquiring section 195.

The control unit 80 notifies the user (outputs to the outside) of the surrounding environment information supplied from the navigation system 190, via the display device 160 and the voice output device 180, and judges by use of this surrounding environment information whether or not the low-temperature countermeasure control is necessary (details will be described later).

Judgment processing of the present system will hereinafter be described.

(2) Operation of Embodiment

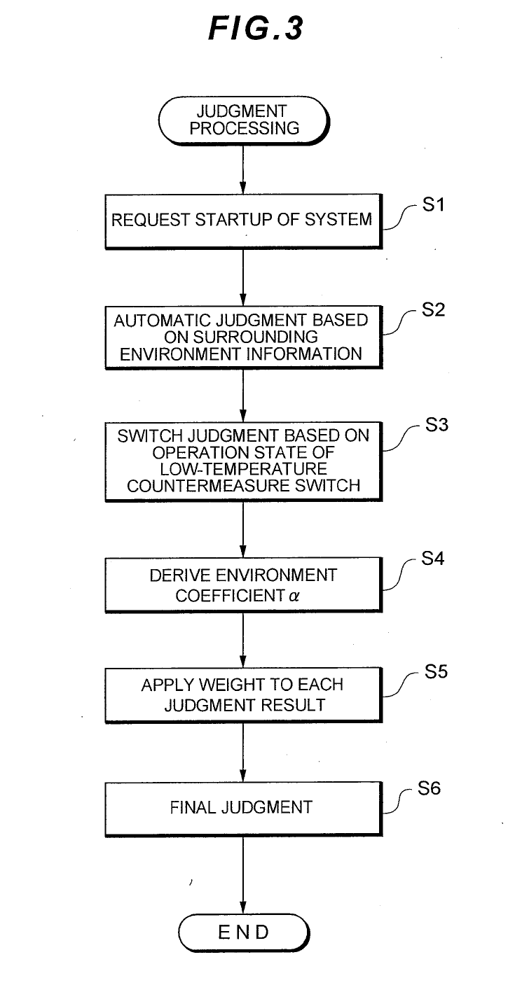

FIG. 3 is a flow chart showing judgment processing to be executed by the control unit 80.

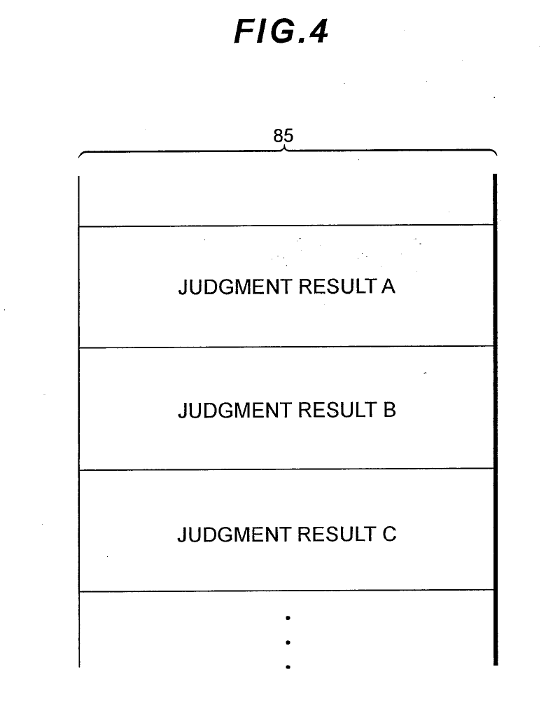

On detecting that a startup request of the system (ignition-on or the like) has been input (step S1), the control unit (first judgment means) 80 acquires the surrounding environment information from the navigation system 190, and automatically judges based on the acquired surrounding environment information whether or not low-temperature countermeasure control is necessary (step S2). Then, the control unit 80 stores judgment result A of this automatic judgment in a predetermined area of a memory 85 (see FIG. 4).

The automatic judgment will be described in detail. First, the control unit 80 requests the surrounding environment information with respect to the navigation system 190. The positional information acquiring section 191 of the navigation system 190 acquires the positional information by use of the GPS, the electronic compass module and the like, and sends the information to the environment information acquiring section 195. The environment information acquiring section 195 transmits the positional information acquired by the positional information acquiring section 191 to the information server 200 via the communicating section 192 and the network IN. The information server 200 extracts the map information indicating the present position (the position at the time) of the vehicle and the surrounding district from the received positional information, extracts the weather information indicating the weather of the surrounding district and the like from the respective databases DB1, DB2, and returns the information to the environment information acquiring section 195. The environment information acquiring section 195 acquires the map information and the weather information in this manner, and additionally acquires the present time information, the outside air temperature information and the FC temperature information from the date mechanism 193, the outside air temperature sensor 194 and the temperature sensor 50, respectively. On acquiring these pieces of surrounding environment information, the environment information acquiring section 195 supplies the information to the control unit 80.

On receiving the surrounding environment information from the environment information acquiring section 195, the control unit 80 automatically judges based on the received surrounding environment information whether or not to perform the low-temperature countermeasure control. One example will be described. For example, threshold values are set to these pieces of information, respectively, and it is judged that the low-temperature countermeasure control is “necessary” in a case where the number of values exceeding this threshold value is three or more, whereas it is judged that the low-temperature countermeasure control is “unnecessary” in a case where the number of the values is less than three. Then, the control unit 80 stores the first judgment result A indicating the result of the above automatic judgment in the predetermined area of the memory 85 (see FIG. 4). Needless to say, such a judgment standard is merely one example, and the judgment standard to be employed is arbitrary.

When the control unit (second judgment means) 80 advances to step S3, the unit performs switch judgment of whether or not the low-temperature countermeasure control is necessary based on an operated state of the low-temperature countermeasure switch SW1. Specifically, when the low-temperature countermeasure switch SW1 is pressed, it is judged that the low-temperature countermeasure control is “necessary”, whereas when the low-temperature countermeasure switch SW1 is not pressed, it is judged that the low-temperature countermeasure control is “unnecessary”. Then, the control unit 80 stores judgment result B of the above switch judgment in a predetermined area of the memory 85 (see FIG. 4).

On storing the judgment results A, B in the predetermined areas of the memory 85, the control unit 80 derives an environment coefficient α based on the above-mentioned surrounding environment information (step S4). This environment coefficient α is a coefficient for determining weights to be applied to the respective judgment results A, B, and the control unit 80 obtains the environment coefficient α (0≦α≦1) by use of the map information, the weather information, the present time information, the outside air temperature information, the FC temperature information and the like included in the surrounding environment information. It is to be noted that a way to use the surrounding environment information in obtaining the environment coefficient α is arbitrary. For example, the environment coefficient α may be determined based on a part (the only map information) of the information included in the surrounding environment information by use of predetermined map and function, or the environment coefficient α may be determined based on all the information included in the surrounding environment information.

On obtaining the environment coefficient α in this manner, the control unit (weighting means) 80 substitutes this coefficient into the following equation (1) to weight the respective judgment results (step S5). Then, the control unit (the third judgment means) 80 finally judges whether or not the low-temperature countermeasure control is necessary (step S6), and stores judgment result C of this final judgment in a predetermined area of the memory 85 (see FIG. 4).

C=α*A+(1−α)*B (1).

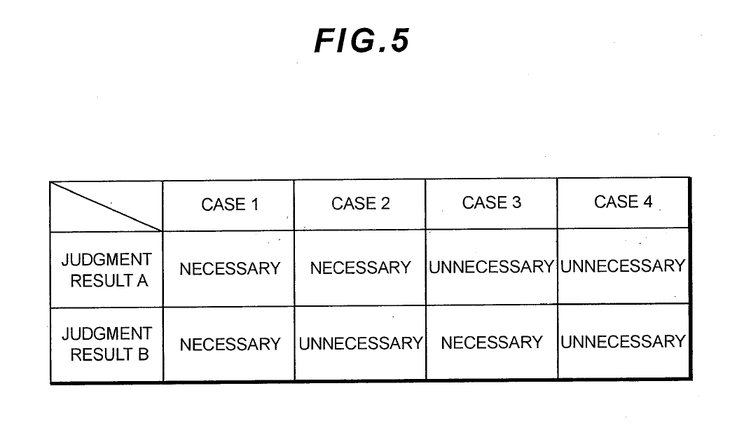

FIG. 5 is a diagram illustrating the judgment results A, B stored in the memory 85. It is to be noted that in FIG. 5, the judgment result indicating that the low-temperature countermeasure control is necessary is shown as “necessary”, and the judgment result indicating that the low-temperature countermeasure control is unnecessary is shown as “unnecessary”.

As shown in FIG. 5, there are four combinations of the judgment results A, B: a case where both the judgment results A, B are “necessary” (case 1); a case where the judgment result A is “necessary” and the judgment result B is “unnecessary” (case 2); a case where the judgment result A is “unnecessary” and the judgment result B is “necessary” (case 3); and a case where both the judgment results A, B are “unnecessary” (case 4). When both the judgment results are the same (cases 1, 4), the judgment result C does not fluctuate in accordance with a value of the environment coefficient α. However, when the judgment results A, B are different from each other (cases 2, 3), the judgment result C fluctuates in accordance with the environment coefficient α.

For example, in the case where the judgment result A is “necessary” and the judgment result B is “unnecessary” (case 2), when the environment coefficient α is set to be less than 0.5, the control unit 80 applies a larger weight to the judgment result B than to the judgment result A, and the judgment result C is the same “unnecessary” as the judgment result B. On the other hand, in the case where the judgment result A is “necessary” and the judgment result B is “unnecessary” (case 2), when the environment coefficient α is set to 0.5 or less, conversely the control unit 80 applies a larger weight to the judgment result A than to the judgment result B, and the judgment result C is the same “necessary” as the judgment result A. In this manner, the weight to be applied by the control unit 80 is changed in accordance with the value of the set environment coefficient α.

When the control unit 80 executes the above-mentioned judgment processing to obtain the judgment result C indicating the judgment result of the final judgment, the control unit controls the present system according to this judgment result. That is, when the judgment result C is “unnecessary”, operation control is usually performed without performing the low-temperature countermeasure control. On the other hand, when the judgment result C of the final judgment is “necessary”, the low-temperature countermeasure control is performed according to this judgment result. Here, examples of the low-temperature countermeasure control include sweep processing. Such sweep processing can be executed to reduce an amount of water accumulated in a pipe or the like, and a problem that the water accumulated in the pipe freezes to break the pipe or the like can be suppressed. Needless to say, the low-temperature countermeasure control is not limited to the sweep processing, and, for example, an operation (low-efficiency operation) may be performed in a state in which power generation efficiency is low, and the system may be warmed up to reduce the amount of the water accumulated in the pipe or the like.

As described above, according to the present embodiment, when necessity of the low-temperature countermeasure control is judged, both of the judgment result of the automatic judgment based on the environment information and the judgment result of the switch judgment based on the user's operation of the low-temperature countermeasure control switch are weighted, and the final judgment is performed based on the respective weighted judgment results. Such weighting is performed, whereby precision of the judgment concerning the necessity of the low-temperature countermeasure control can be improved, and useless low-temperature countermeasure control can be suppressed. Moreover, the low-temperature countermeasure control can be performed at an appropriate timing when necessary.

It is to be noted that in the above-mentioned present embodiment, the judgment processing is performed during the startup of the system, but the judgment processing may be performed in a case where there is a request for stop of the system, and further the judgment processing may intermittently be performed during a usual operation. When the judgment result A of the automatic judgment is “necessary” in the above judgment processing, a message which urges input of the low-temperature countermeasure control instruction may be notified.

1. A fuel cell system provided with a low-temperature countermeasure operator which instructs execution of low-temperature countermeasure control, the system comprising:
first judgment means for judging necessity of the low-temperature countermeasure control based on acquired environment information;
second judgment means for judging the necessity of the low-temperature countermeasure control based on operation contents of the low-temperature countermeasure operator operated by a user;
weighting means for applying weights to judgment results obtained by the respective judgment means; and
third judgment means for finally judging whether or not to execute the low-temperature countermeasure control based on the respective weighted judgment results.

2. The fuel cell system according to claim 1, wherein the weighting means changes the weight to be applied in accordance with contents of the acquired environment information.

3. The fuel cell system according to claim 1, wherein the environment information includes information indicating at least one of a temperature of a fuel cell, an outside air temperature, a position at the time and a date.

4. The fuel cell system according to claim 2, wherein the environment information includes information indicating at least one of a temperature of a fuel cell, an outside air temperature, a position at the time and a date.

5. The fuel cell system according to claim 1, which further comprises output means for outputting the acquired environment information to the outside.

6. The fuel cell system according to claim 2, which further comprises output means for outputting the acquired environment information to the outside.

7. The fuel cell system according to claim 1, wherein the environment information includes information indicating at least two or more of a temperature of a fuel cell, an outside air temperature, a position at the time and a date, and
the first judgment means compares two or more pieces of information included in the environment information with a set threshold value corresponding to each information to judge the necessity of the low-temperature countermeasure control based on the number of pieces of the information exceeding the threshold value.

8. The fuel cell system according to claim 2, wherein the environment information includes information indicating at least two or more of a temperature of a fuel cell, an outside air temperature, a position at the time and a date, and
the first judgment means compares two or more pieces of information included in the environment information with a set threshold value corresponding to each information to judge the necessity of the low-temperature countermeasure control based on the number of pieces of the information exceeding the threshold value.

9. The fuel cell system according to claim 1, wherein the first judgment means judges the necessity at a time of startup of the system or at a time of request for stop of the system.

10. The fuel cell system according to claim 2, wherein the first judgment means judges the necessity at a time of startup of the system or at a time of request for stop of the system.

11. The fuel cell system according to claim 1, which further comprises notification means for notifying a message to urge input of a low-temperature countermeasure control instruction by the low-temperature countermeasure operator, in a case where the first judgment means judges that the low-temperature countermeasure control is necessary.

12. The fuel cell system according to claim 2, which further comprises notification means for notifying a message to urge input of a low-temperature countermeasure control instruction by the low-temperature countermeasure operator, in a case where the first judgment means judges that the low-temperature countermeasure control is necessary.

13. The fuel cell system according to claim 1, wherein the low-temperature countermeasure control is one of sweep processing and warm-up processing in which the system is operated in a state in which power generation efficiency is low.

14. The fuel cell system according to claim 2, wherein the low-temperature countermeasure control is one of sweep processing and warm-up processing in which the system is operated in a state in which power generation efficiency is low.
